(19) United States
(12) Patent Application Publication
(10) Pub. No.: US 2024/0267212 A1
(43) Pub. Date: Aug. 8, 2024

(54) Post-Quantum Cryptography Key Encapsulation Mechanism System

(71) Applicant: Intel Corporation, Santa Clara, CA (US)

(72) Inventors: Santosh Ghosh, Hillsboro, OR (US); Manoj Sastry, Portland, OR (US)

(73) Assignee: Intel Corporation, Santa Clara, CA (US)

(21) Appl. No.: 18/164,487

(22) Filed: Feb. 3, 2023

(51) Int. Cl. H04L 9/08; H04L 9/30

(52) U.S. Cl. CPC H04L 9/0869; H04L 9/3093

(57) ABSTRACT

Key encapsulation implemented by random sample generator circuitry to generate a plurality of pseudorandom bitstreams; polynomial multiplier circuitry to multiply a plurality of polynomial coefficients; and a controller to power off the polynomial multiplier circuitry and power on the random sample generator circuitry to generate the plurality of pseudorandom bitstreams, and power off the random sample generator circuitry and power on the polynomial multiplier circuitry to multiple the plurality of polynomial coefficients.

### BACKGROUND

In cryptographic protocols, a key encapsulation mechanism (KEM) is used to secure symmetric key material for transmission using asymmetric (e.g., public key) algorithms. In practice, public key systems are clumsy to use in transmitting long messages. Instead, they are often used to exchange symmetric keys, which are relatively short. The symmetric key is then used to encrypt the longer message. A KEM generates a random element in the finite group underlying the public key system and deriving the symmetric key by hashing that element, eliminating the need for padding.

The intractability assumption of the computational problems that common classical digital cryptography schemes rely on will be broken in future by quantum computers. New KEMs that are resistant to attacks by quantum computers are being developed. However, such KEMs are too slow and too energy-intensive for a post quantum secure system on a chip (SOC).

### BRIEF DESCRIPTION OF DRAWINGS

Various examples in accordance with the present disclosure will be described with reference to the drawings.

FIG. 1 is a block diagram of a computing system in one implementation.

FIG. 2 is a block diagram of an accelerator in one implementation.

FIG. 3 illustrates KEM circuitry according to an implementation.

FIG. 4 illustrates random sample generator circuitry according to an implementation.

FIG. 5 illustrates polynomial multiplication circuitry according to an implementation.

FIG. 6 is a flow diagram of random sample generator processing according to an implementation.

FIG. 7 is a flow diagram of polynomial multiplication processing according to an implementation.

FIG. 8 illustrates an example computing system.

FIG. 9 illustrates a block diagram of an example processor and/or System on a Chip (SoC) that may have one or more cores and an integrated memory controller.

FIG. 10(A) is a block diagram illustrating both an example in-order pipeline and an example register renaming, out-of-order issue/execution pipeline according to examples.

FIG. 10(B) is a block diagram illustrating both an example in-order architecture core and an example register renaming, out-of-order issue/execution architecture core to be included in a processor according to examples.

FIG. 11 illustrates examples of execution unit(s) circuitry.

FIG. 12 is a block diagram of a register architecture according to some examples.

### DETAILED DESCRIPTION

The present disclosure relates to methods, apparatus, and systems to perform key encapsulation in a computing system. In an implementation, the key encapsulation mechanism (KEY) comprises a Cryptographic Suite for Algebraic Lattices (CRYSTALS) Kyber process as described in “CRYSTALS-Kyber—Algorithm Specifications and Supporting Documentation”, version 3.02, Aug. 4, 2021, and later versions, by Roberto Avanci, et al.

The technology described herein improves Kyber computation in a computing system to reduce the overall energy and latency budgets. Kyber computation is based on four major building blocks: 1) generating random bitstreams using the Keccak mathematical function, 2) parsing to generate coefficients of the public polynomials from the random bitstreams; 3) number theoretic transform (NTT) operations; and 4) coefficient-wise multiplications. The Keccak mathematical function is described in Secure Hash Algorithm (SHA-3) standard “Permutation-Based Hash and Extendible-Output Functions”, Federal Information Processing Standards (FIPS) publication (Pub) 202, August 2015.

According to some examples, the technologies described herein may be implemented in one or more electronic devices. Non-limiting examples of electronic devices that may utilize the technologies described herein include any kind of computing system, mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, disaggregated server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide post-quantum key encapsulation.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

The CRYSTALS-Kyber process is compute-intensive and requires significant power and latency to compute key generation, encapsulation, and decapsulation functions. Serial execution of polynomial generation actions keeps the Keccak mathematical function active for longer periods of time, resulting in additional power consumption. Power consumption is a major factor when seeking to optimize designs for SoCs and other computing systems. The technology described herein optimizes the energy and latency needed for Kyber computation to reduce the power and latency budgets for post-quantum secure SoCs and other computing systems.

In an implementation, overall power usage and the latency of Kyber computations are reduced through the following principles. The 256 12-bit coefficients for a single polynomial in a public matrix A of Kyber are computed. The coefficients are the output of a Central Binomial Distribution known as a Parse function in Kyber. From a lowest latency perspective, all 256 coefficients could be generated in parallel, but this would require a 3,073-bit wide memory, which is too inefficient for a low energy solution. In contrast, in an implementation, iterative Keccak circuitry generates a 1,344-bit random input to the Parse function within six cycles, thus imposing a more reasonable constraint on usage of memory bandwidth of 192 bits (instead of 3,072 bits). Additionally, the latency of one polynomial generation is reduced to 21 cycles, compared to 72 cycles with an existing design. Optimal polynomial multiplier circuitry is included that comprises eight butterfly units to utilize the full bandwidth of the memory and processes sixteen 12-bit coefficients (thus 192 bits) in each cycle to compute the NTT operations, which results in 112 cycles of latency for one Kyber NTT. This is in contrast to the 896 cycles needed in an existing design (consisting of one butterfly unit to process two coefficients). The novel approach described herein also results in approximately 7× lower energy usage compared to an existing design.

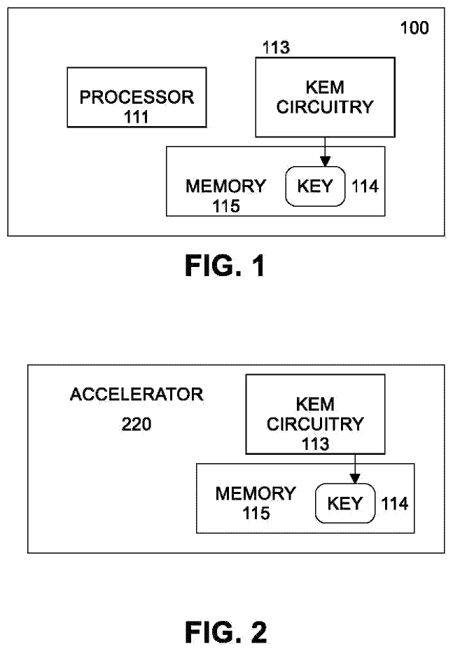

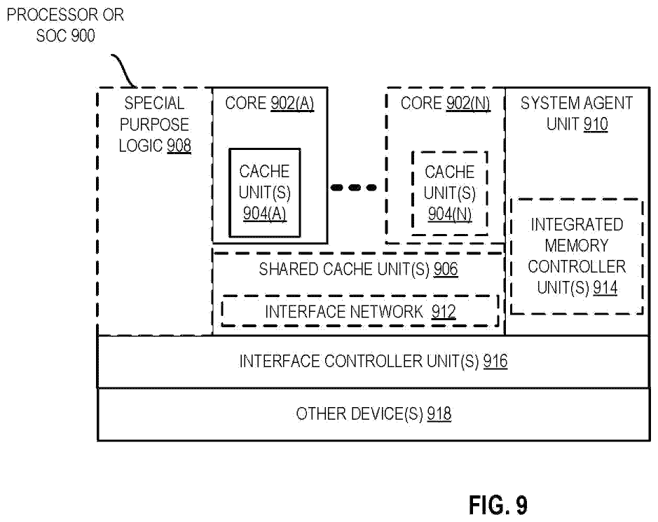

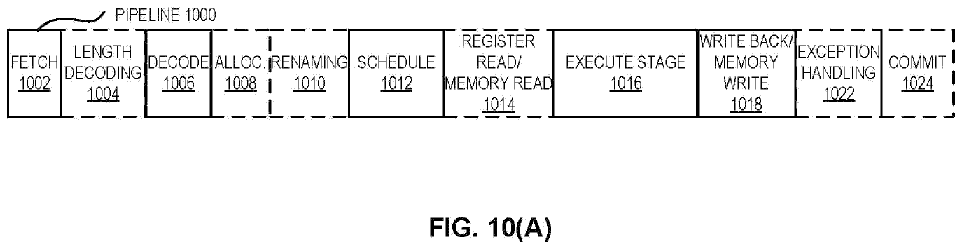

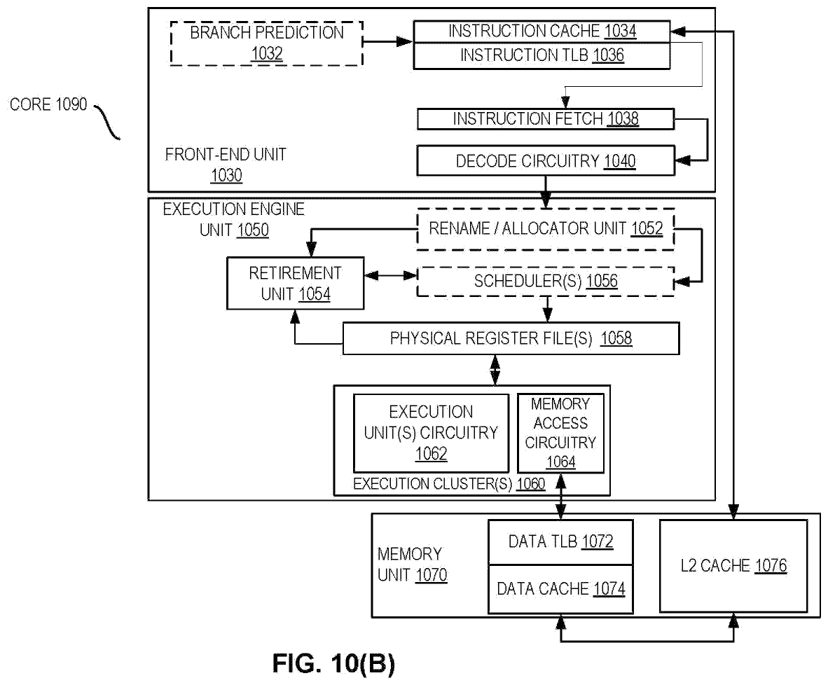

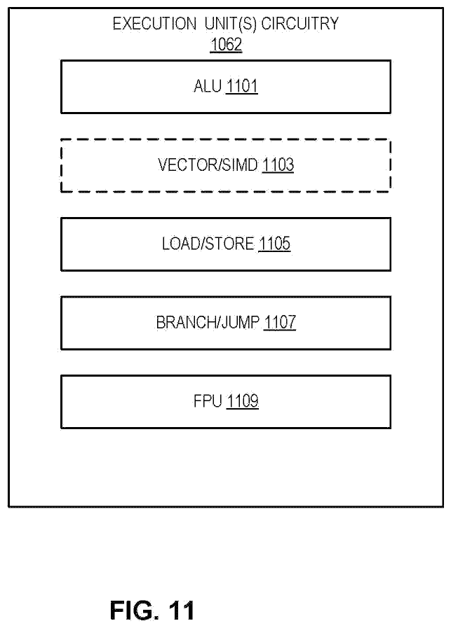

With reference to FIG. 1, an example of a computing system 100 may include a processor 111 to perform data processing operations, and key encapsulation mechanism (KEM) circuitry 113, coupled to processor 111, to perform key encapsulation operations. For example, processor 111 may be implemented as any of the processors described below. KEM circuitry 113 may also be incorporated in processor 111, such as processor 800, processor 870, processor 815, coprocessor 838, and/or processor/coprocessor 880 (FIG. 8), processor 900 (FIG. 9), core 1090 (FIG. 10(B)), and execution units 1062 (FIGS. 10(B) and 11). In an implementation, KEM circuitry 113 implements the CRYSTALS-Kyber KEM process to output a key 114, which may be stored in a memory 115.

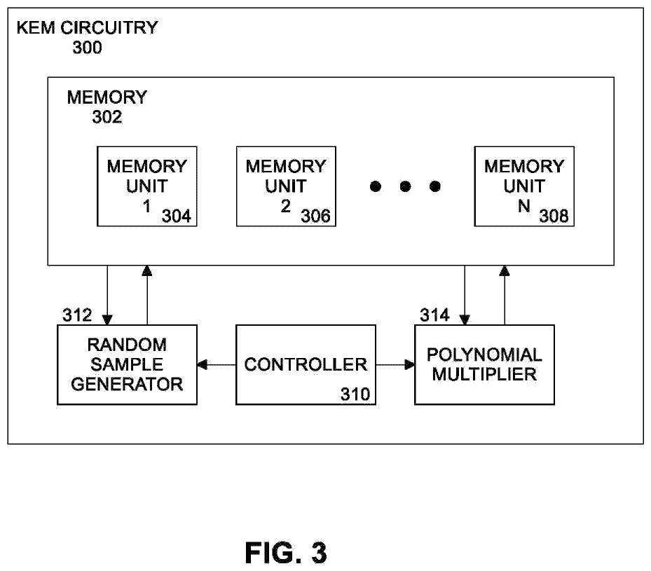

With reference to FIG. 2, an example of an accelerator 220 to perform data processing operations and including KEM circuitry 113 to perform key encapsulation operations is shown. For example, accelerator 220 may be part of computing system 100. In an implementation, KEM circuitry 113 implements the CRYSTALS-Kyber KEM process to output a key 114, which may be stored in a memory 115.

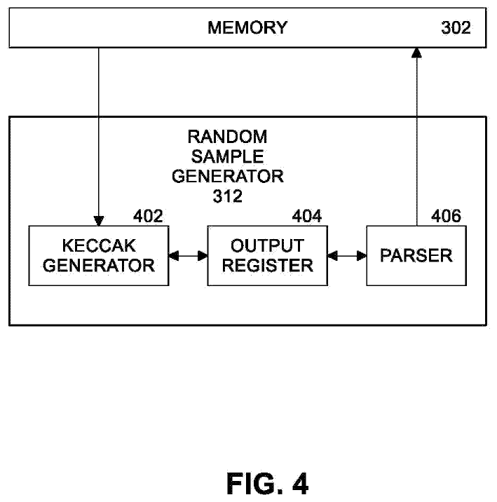

FIG. 3 illustrates KEM circuitry 300 according to an implementation. KEM circuitry 300 is an instance of KEM circuitry 113 of processor 111, accelerator 220, or computing system 100. As shown in FIG. 3, KEM circuitry 300 comprises memory 302 (within KEM circuitry 300) having a plurality of independently readable and writable memory units with independent ports such as memory unit 1 304, memory unit 2 306, . . . memory unit N 308, where N is a natural number. In an implementation, N is 8. In another implementation, N is 16.

Random sample generator (RSG) 312 is coupled to memory 302 to read from and write to one or more of the memory units of memory 302. Polynomial multiplier (PM) 314 is also coupled to memory 302 to read from and write to one or more of the memory units of memory 302. RSG 312 and PM 314 provide computations for Kyber key generation, encryption, and decryption that reduce the overall energy and latency budgets for KEM circuitry 300. Controller 310 is coupled to RSG 312 and PM 314 to control the KEM process.

The memory units 304, 306, . . . 308 include independent ports to support multiple reads and/or writes in parallel. In Kyber, the operands/polynomial-coefficients are 12-bits long and so the read/write ports in the memory units are all 12-bits wide. However, in another implementation the memory ports could be larger than 12 bits wherein the other bits in a memory word remain unused or may be used to fit more than one Kyber operand. In this case, additional RSGs and PMs may utilize the memory unit in parallel. For example, there may be multiple butterfly units (described below) to compute the NTT operations or coefficient-wise multiplications in parallel with the coefficients stored in the same memory words. Similarly, the RSG in that case will be able to generate multiple coefficients in parallel and store them in the same word in memory 302.

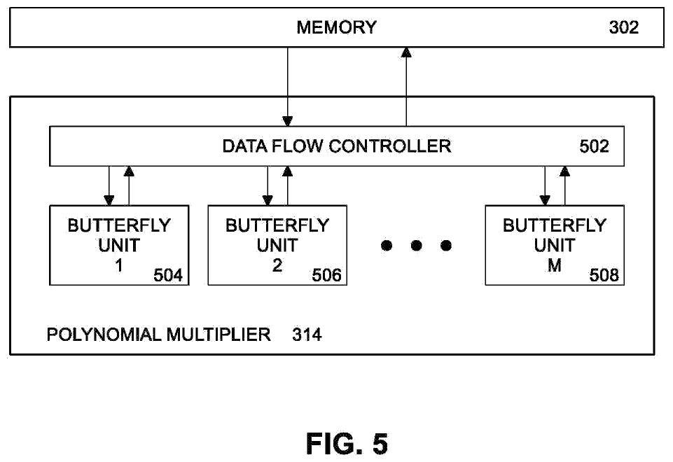

FIG. 4 illustrates random sample generator (RSG) 312 circuitry according to an implementation. RSG 312 comprises Keccak generator 402 coupled to output register 404, which is coupled to parser 406. Keccak generator 402 reads seed data from one or more memory units 304, 306, . . . 308 of memory 302, combines the seed data with an index value received from controller 310 and executes 24-round Keccak operations. Keccak generator 402 writes output data (pseudorandom bitstreams with 1,344 bits for public key expansion) to output register 404. Parser reads the 1,344 bits from output register 404. Parser 406 computes multiple coefficients of a polynomial in parallel. Parser 406 writes the coefficients of the polynomial to one or more memory units 304,306, . . . 308 of memory 302.

For example, the public matrix A in Kyber consists of 4, 9 and 16 polynomials. Each of these polynomials are generated from different seeds, comprising row and column positions of the public matrix A. Each coefficient of these polynomials is 12 bits long. The random bits are generated through the SHAKE128 NIST standard hash/eXtented Output Function (XOF) function (as described in FIPS 202) which computes 1,344 bits after every 24 rounds of Keccak operation. In Kyber, these coefficients are generated through a parse function (e.g., implemented as parser 406) which takes three bytes (24-bits) from the XOF output and computes at most two coefficients. For the fastest generation of one polynomial, Keccak generator 402 computes one SHAKE128 every seven cycles. Similarly, to utilize the 1,344-bit XOF output before the next one is produced by the Keccak generator 402, eight sets of three-byte chunks are processed in every cycle in parser 406, which results in seven cycles latency to process a 1,344-bit XOF output. Thus, parser 406 and Keccak generator 402 are fully utilized in parallel and provide the most optimal latency for generating one polynomial at a time. Note that this also requires memory 302 to support 192 bits (e.g., 8×2×12) bits of simultaneous write capability. This capability may be implemented with a single 192-bit wide memory 302 or multiple memory units (e.g., 304, 306, . . . 308) with shorter port widths, where each port width may be a multiple of 12-bits.

In an implementation, a single copy of RSG 312 may be used iteratively to compute 4, 9 and 12 polynomials for Kyber-512, Kyber-768 and Kyber-1024 configurations. This approach requires at most 21 (3×7) cycles per polynomial generation, which results in 84 (4×21), 189 (9×21) and 336 (16×21) cycles to generate the entire public matrix A for the respective Kyber configurations (e.g., Kyber-512, Kyber-768 and Kyber-1024). This provides an optimal design to reduce static energy consumption.

In another implementation, a plurality of RSGs may be incorporated into KEM circuitry 300 to further reduce the overall latency. For example, if two RSGs are used then the resulting latency numbers will be 42, 105 and 168 cycles for generating the matrix A for the respective Kyber configurations (e.g., Kyber-512, Kyber-768 and Kyber-1024).

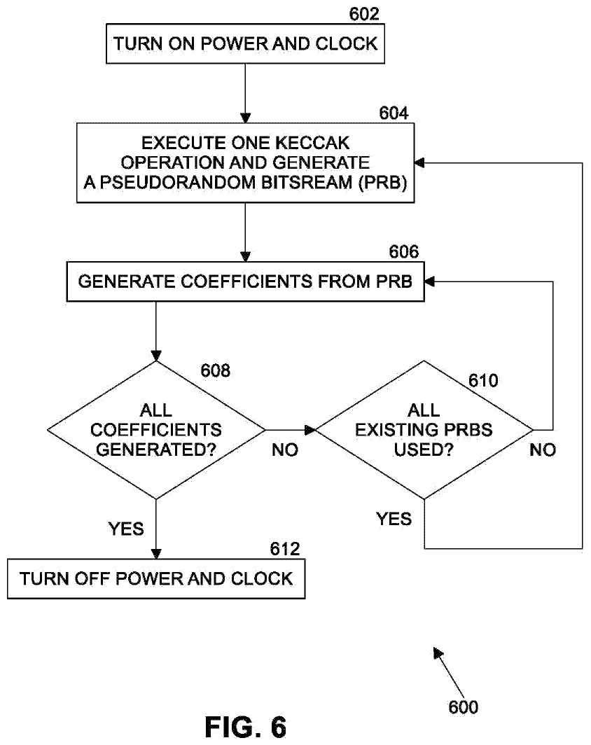

FIG. 5 illustrates polynomial multiplication (PM) 314 circuitry according to an implementation. PM 314 comprises a plurality of butterfly units, such as butterfly units 1 504, butterfly unit 2 506, . . . butterfly unit M 508, where M is a natural number. In an implementation, M is eight. In another implementation, M is 16. PM 314 comprises data flow controller 503 to control reading data from one or more memory units 304, 306, . . . 308 of memory 302 by one or more butterfly units and writing data to one or more memory units 304,306, . . . 308 of memory 302 by the one or more butterfly units.

Each Kyber polynomial has 256 coefficients which are divided in two buckets: even index coefficients and odd index coefficients. The Number Theoretic Transform (NTT) operation is performed independently on these two buckets. To perform the NTT operations efficiently with low latency and to utilize the full memory bandwidth (16 coefficients are read/write in parallel as per RSG 312), in an implementation eight butterfly units are included in PM 314. Each of the butterfly units (e.g., butterfly units 1 504, butterfly unit 2 506, . . . butterfly unit M 508) is configurable to perform both of the Cooley-Tukey (CT) butterfly and the Gentleman-Sande (GS) butterfly computations required for the NTT phase and the Inverse-NTT phase on 128 coefficients. In total for all seven phases, PM 314 takes 56 cycles. Therefore, in an implementation of PM 314, one NTT operation for an entire Kyber polynomial of 256 coefficients has a latency of 112 cycles.

KEM circuitry 300 includes separate power gates (not shown) for RSG 312 and PM 314 which supports the capability to turn RSG 312 and PM 314 on and off independently (e.g., power on and power off) under the control of controller 310. This results in a reduction of the energy budget for KEM circuitry 399. In the execution of Kyber procedures such as encryption/encapsulation, the public matrix A and the random polynomials in r and error polynomials in vector e1 and e2 may be generated first by RSG 312 while PM 314 is power gated (powered off). In the second part of the execution, RSG 312 is power gated (powered off) while only the PM 314 remains powered on and computes all polynomial operations. Finally for the last part of the encryption, both RSG 312 and PM 314 are powered off while only controller 310 (or a separate circuit in KEM circuitry controlled and/or configured by controller 310) computes the compression and encoding remains powered on and generates the ciphertext.

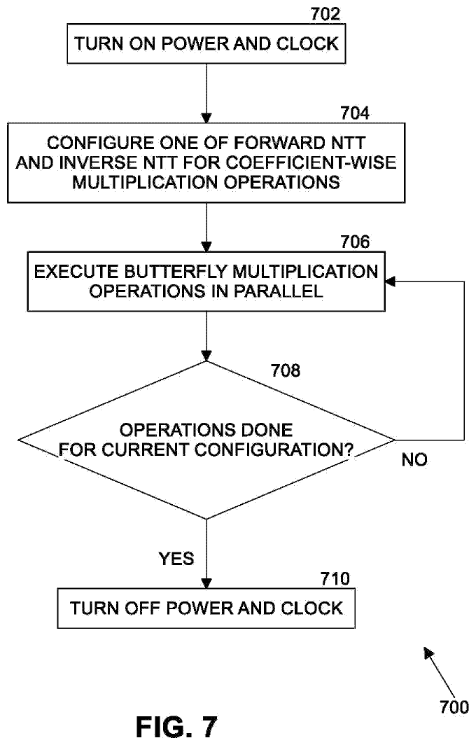

FIG. 6 is a flow diagram of random sample generator processing 600 according to an implementation. At block 602, controller 310 turns on power and the clock for RSG 312. At block 604, Keccak generator 402 of RSG 312 executes one Keccak operation and generates a pseudorandom bitstream (PRB). In an implementation, Keccak generator 402 generates a 1,344-bit PRB (e.g., for use as a public key). In another implementation, Keccak generator 402 generates a 1,088-bit PRB (e.g., for use as a secret and/or error polynomials). At block 606, parser 406 generates coefficients from the PRB. In an implementation, 16 coefficients are generated in parallel. At block 608, if all coefficients have not been generated, then at block 610 if all existing PRBs have been used, RSG processing returns to block 604 for execution of another Keccak operation, depending on rejection sampling of parser 406. In an implementation, there may be three iterations of the Keccak operation. If at block 610 all existing PRBs have not been used, then RSG processing returns to block 606 to generate coefficients the next polynomial. For public key generation, 1,344-bit PRBs are generated at a time. For private key and error polynomials 1,088-bit PRBs are generated at a time. At block 608, if all coefficients have been generated for all the polynomials in public key, private key and error vectors, then controller 310 turns off the power and the clock of RSG 312.

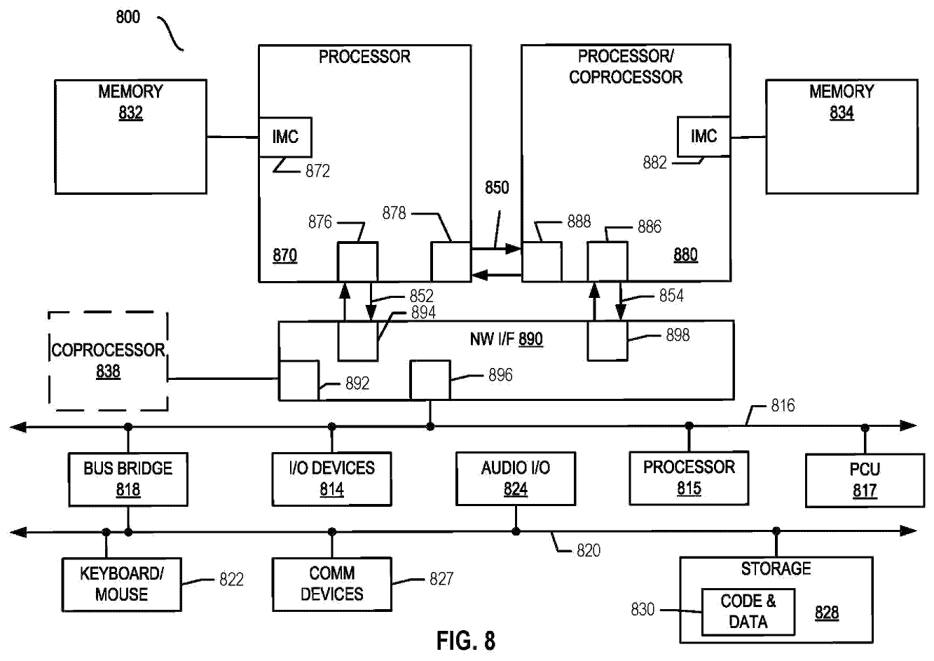

FIG. 7 is a flow diagram of polynomial multiplication processing 700 according to an implementation. At block 702, controller 310 turns on power and the clock for PM 314. At block 704, controller 310 configures PM 314 (e.g., by setting a register (not shown) in PM 314) for one of forward NTT and inverse-NTT for coefficient-wise multiplication operations. At block 706, the butterfly units 1 504, 2 506, . . . M 508 execute butterfly multiplication operations on 16 coefficients (in total) in parallel, with each butterfly unit executing butterfly multiplication operations on two coefficients.

Data flow controller 502 reads the coefficients of the polynomial and writes back the updated coefficient values for both NTT and Inverse-NTT operations. Data flow controller 502 reads two coefficients of two polynomials and writes the multiplication result of those two operands. In an implementation, eight such operations are executed in parallel, resulting in reading and writing 16 coefficients in parallel.

At block 708, if the butterfly multiplication operations are not done for the current configuration (e.g., either NTT or inverse-NTT), then processing returns to block 706 to execute butterfly multiplication operations on the next set of coefficients. If the butterfly multiplication operations are done for the current configuration, then controller 310 turns off the power and the clock for PM 314.

Once one NTT operation is complete, PM 314 is engaged for the next NTT and so on. Then the PM computes the necessary polynomial multiplications involved in the Kyber process in the NTT domain. PM 314 also computes the Inverse-NTT operations by following the same iterative approach described above by processing 16 coefficients at a time. Once all polynomial operations have been completed, then PM 314 is powered down by controller 310.

### Example Computer Architectures.

Detailed below are descriptions of example computer architectures. Other system designs and configurations known in the arts for laptop, desktop, and handheld personal computers (PCs), personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is a SoC.

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via an interface circuit 896. In some examples, first interface 816 may be an interface such as a Peripheral Component Interconnect (PCI) interconnect, a PCI Express interconnect or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage 'ISAB03 in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include, on the same die as the described CPU (sometimes referred to as the application core(s) or application processor(s)), the above described coprocessor and additional functionality. Example core architectures are described next, followed by descriptions of example processors and computer architectures.

FIG. 9 illustrates a block diagram of an example processor and/or SoC 900 that may have one or more cores and an integrated memory controller. The solid lined boxes illustrate a processor 900 with a single core 902(A), system agent unit circuitry 910, and a set of one or more interface controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interface controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller units circuitry 916 couple the cores 902 to one or more other devices 918 such as one or more I/O devices, storage, one or more communication devices (e.g., wireless networking, wired networking, etc.), etc.

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

Example Core Architectures—In-order and out-of-order core block diagram.

FIG. 10(A) is a block diagram illustrating both an example in-order pipeline and an example register renaming, out-of-order issue/execution pipeline according to examples. FIG. 10(B) is a block diagram illustrating both an example in-order architecture core and an example register renaming, out-of-order issue/execution architecture core to be included in a processor according to examples. The solid lined boxes in FIGS. 10(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10(A), a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 10(B) may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10(B) shows a processor core 1090 including front-end unit circuitry 1030 coupled to execution engine unit circuitry 1050, and both are coupled to memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front-end unit circuitry 1030 may include branch prediction circuitry 1032 coupled to instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front-end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, address generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to data cache circuitry 1074 coupled to level 2 (L2) cache circuitry 1076. In one example, the memory access circuitry 1064 may include load unit circuitry, store address unit circuitry, and store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Example Execution Unit(s) Circuitry.

FIG. 11 illustrates examples of execution unit(s) circuitry, such as execution unit(s) circuitry 1062 of FIG. 10(B). As illustrated, execution unit(s) circuitry 1062 may include one or more ALU circuits 1101, optional vector/single instruction multiple data (SIIvD) circuits 1103, load/store circuits 1105, branch/jump circuits 1107, and/or Floating-point unit (FPU) circuits 1109. ALU circuits 1101 perform integer arithmetic and/or Boolean operations. Vector/SEID circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

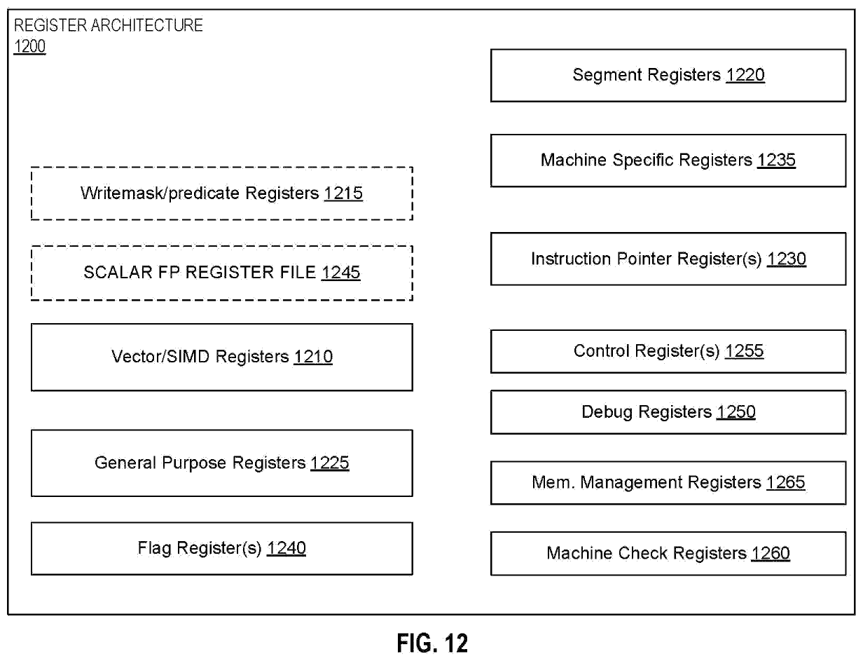

FIG. 12 is a block diagram of a register architecture 1200 according to some examples. As illustrated, the register architecture 1200 includes vector/SIMD registers 1210 that vary from 128-bit to 1,024 bits width. In some examples, the vector/SEID registers 1210 are physically 512-bits and, depending upon the mapping, only some of the lower bits are used. For example, in some examples, the vector/SID registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and comprises a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register file 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 comprise control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a global descriptor table register (GDTR), interrupt descriptor table register (IDTR), task register, and a local descriptor table register (LDTR).

Alternative examples may use wider or narrower registers. Additionally, alternative examples may use more, less, or different register files and registers. The register architecture 1200 may, for example, be used in register file/memory 'ISAB08, or physical register file(s) circuitry 1058.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions and coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, certain examples are not described with reference to any particular programming language. It will be appreciated that a variety of programming languages may be used to implement the teachings of such examples as described herein.

### Examples

Example 1 is an apparatus including random sample generator circuitry to generate a plurality of pseudorandom bitstreams; polynomial multiplier circuitry to multiply a plurality of polynomial coefficients; and a controller to power off the polynomial multiplier circuitry and power on the random sample generator circuitry to generate the plurality of pseudorandom bitstreams, and power off the random sample generator circuitry and power on the polynomial multiplier circuitry to multiple the plurality of polynomial coefficients.

In Example 2, the subject matter of Example 1 may optionally include a memory including a plurality of independently readable and writable memory units, the random sample generator circuitry and the polynomial multiplier circuitry to independently read from and write to the plurality of independently readable and writable memory units. In Example 3, the subject matter of Example 3 may optionally include wherein a number of the plurality of independently readable and writable memory units is 8 and a bandwidth of the memory is 192 bits per cycle. In Example 4, the subject matter of Example 1 may optionally include wherein the random sample generator circuitry and the polynomial multiplier circuitry execute a Cryptographic Suite for Algebraic Lattices (CRYSTALS) Kyber process for key encapsulation. In Example 5, the subject matter of Example 1 may optionally include wherein the random sample generator circuitry generates the plurality of pseudorandom bitstreams using a Keccak mathematical function. In Example 6, the subject matter of Example 2 may optionally include wherein the random sample generator circuitry includes Keccak generator circuitry to read seed data from the memory and execute a plurality of Keccak operations to generate the plurality of pseudorandom bitstreams; and parser circuitry to generate the plurality of polynomial coefficients in parallel from the plurality of pseudorandom bitstreams and write the plurality of polynomial coefficients to the memory.

In Example 7, the subject matter of Example 6 may optionally include wherein the Keccak generator circuitry generates one pseudorandom bitstream every seven cycles and parser circuitry generates the plurality of polynomial coefficients every seven cycles, in parallel. In Example 8, the subject matter of Example 2 may optionally include wherein the polynomial multiplier circuitry includes a plurality of butterfly units to execute a selected one of number theoretic transform (NTT) operations and inverse NTT operations in parallel on the plurality of polynomial coefficients. In Example 9, the subject matter of Example 8 may optionally include wherein the polynomial multiplier circuitry includes data flow controller circuitry to read polynomial coefficients from the memory and write polynomial coefficients updated by the plurality of butterfly units to the memory in parallel. In Example 10, the subject matter of Example 9 may optionally include wherein a number of the plurality of butterfly units is 8 and the data flow controller circuitry writes 16 polynomial coefficients to the memory in parallel. In Example 11, the subject matter of Example 1 may optionally include the controller to configure the polynomial multiplier circuitry for a selected one of NTT operations and inverse NTT operations.

Example 12 is a method including generating, by a random sample generator, a plurality of pseudorandom bitstreams; multiplying, by a polynomial multiplier, a plurality of polynomial coefficients; and powering off the polynomial multiplier and powering on the random sample generator to generate the plurality of pseudorandom bitstreams, and powering off the random sample generator and powering on the polynomial multiplier to multiple the plurality of polynomial coefficients. In Example 13, the subject matter of Example 12 may optionally include independently reading from and writing to a plurality of independently readable and writable memory units of a memory by random sample generator and the polynomial multiplier. In Example 14, the subject matter of Example 12 may optionally include wherein the random sample generator and the polynomial multiplier execute a Cryptographic Suite for Algebraic Lattices (CRYSTALS) Kyber process for key encapsulation. In Example 15, the subject matter of Example 12 may optionally include generating the plurality of pseudorandom bitstreams using a Keccak mathematical function. In Example 16, the subject matter of Example 13 may optionally include reading seed data from the memory and executing a plurality of Keccak operations by a Keccak generator of the random sample generator to generate the plurality of pseudorandom bitstreams; and generating the plurality of polynomial coefficients in parallel by a parser of the random sample generator from the plurality of pseudorandom bitstreams and writing the plurality of polynomial coefficients to the memory.

In Example 17, the subject matter of Example 16 may optionally include generating one pseudorandom bitstream every seven cycles and generating the plurality of polynomial coefficients every seven cycles, in parallel. In Example 18, the subject matter of Example 13 may optionally include executing a selected one of number theoretic transform (NTT) operations and inverse NTT operations in parallel on the plurality of polynomial coefficients by a plurality of butterfly units of the polynomial multiplier. In Example 19, the subject matter of Example 18 may optionally include reading polynomial coefficients from the memory by a data flow controller and writing polynomial coefficients updated by the plurality of butterfly units to the memory in parallel by the data flow controller. In Example 20, the subject matter of Example 18 may optionally include configuring the polynomial multiplier for a selected one of NTT operations and inverse NTT operations.

Example 21 is a system including a memory to store a key; and key encapsulation mechanism circuitry to generate the key including random sample generator circuitry to generate a plurality of pseudorandom bitstreams; polynomial multiplier circuitry to multiply a plurality of polynomial coefficients; and a controller to power off the polynomial multiplier circuitry and power on the random sample generator circuitry to generate the plurality of pseudorandom bitstreams, and power off the random sample generator circuitry and power on the polynomial multiplier circuitry to multiple the plurality of polynomial coefficients.

In Example 22, the subject matter of Example 21 may optionally include wherein the key encapsulation mechanism circuitry comprise a memory including a plurality of independently readable and writable memory units, the random sample generator circuitry and the polynomial multiplier circuitry to independently read from and write to the plurality of independently readable and writable memory units. In Example 23, the subject matter of Example 21 may optionally include wherein the random sample generator circuitry includes Keccak generator circuitry to read seed data from the memory and execute a plurality ofKeccak operations to generate the plurality of pseudorandom bitstreams; and parser circuitry to generate the plurality of polynomial coefficients in parallel from the plurality of pseudorandom bitstreams and write the plurality of polynomial coefficients to the memory. In Example 24, the subject matter of Example 21 may optionally include wherein the polynomial multiplier circuitry includes a plurality of butterfly units to execute a selected one of number theoretic transform (NTT) operations and inverse NTT operations in parallel on the plurality of polynomial coefficients.

Example 25 is an apparatus operative to perform the method of any one of Examples 12 to 20. Example 26 is an apparatus that includes means for performing the method of any one of Examples 12 to 20. Example 27 is an apparatus that includes any combination of modules and/or units and/or logic and/or circuitry and/or means operative to perform the method of any one of Examples 12 to 20. Example 28 is an optionally non-transitory and/or tangible machine-readable medium, which optionally stores or otherwise provides instructions that if and/or when executed by a computer system or other machine are operative to cause the machine to perform the method of any one of Examples 12 to 20.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
random sample generator circuitry to generate a plurality of pseudorandom bitstreams;
polynomial multiplier circuitry to multiply a plurality of polynomial coefficients; and
a controller to power off the polynomial multiplier circuitry and power on the random sample generator circuitry to generate the plurality of pseudorandom bitstreams, and power off the random sample generator circuitry and power on the polynomial multiplier circuitry to multiple the plurality of polynomial coefficients.

2. The apparatus of claim 1, comprising a memory including a plurality of independently readable and writable memory units, the random sample generator circuitry and the polynomial multiplier circuitry to independently read from and write to the plurality of independently readable and writable memory units.

3. The apparatus of claim 2, wherein a number of the plurality of independently readable and writable memory units is 8 and a bandwidth of the memory is 192 bits per cycle.

4. The apparatus of claim 1, wherein the random sample generator circuitry and the polynomial multiplier circuitry execute a Cryptographic Suite for Algebraic Lattices (CRYSTALS) Kyber process for key encapsulation.

5. The apparatus of claim 1, wherein the random sample generator circuitry generates the plurality of pseudorandom bitstreams using a Keccak mathematical function.

6. The apparatus of claim 2, wherein the random sample generator circuitry comprises:
Keccak generator circuitry to read seed data from the memory and execute a plurality of Keccak operations to generate the plurality of pseudorandom bitstreams; and
parser circuitry to generate the plurality of polynomial coefficients in parallel from the plurality of pseudorandom bitstreams and write the plurality of polynomial coefficients to the memory.

7. The apparatus of claim 6, wherein the Keccak generator circuitry generates one pseudorandom bitstream every seven cycles and parser circuitry generates the plurality of polynomial coefficients every seven cycles, in parallel.

8. The apparatus of claim 2, wherein the polynomial multiplier circuitry comprises:
a plurality of butterfly units to execute a selected one of number theoretic transform (NTT) operations and inverse NTT operations in parallel on the plurality of polynomial coefficients.

9. The apparatus of claim 8, wherein the polynomial multiplier circuitry comprises:
data flow controller circuitry to read polynomial coefficients from the memory and write polynomial coefficients updated by the plurality of butterfly units to the memory in parallel.

10. The apparatus of claim 9, wherein a number of the plurality of butterfly units is 8 and the data flow controller circuitry writes 16 polynomial coefficients to the memory in parallel.

11. The apparatus of claim 1, comprising the controller to configure the polynomial multiplier circuitry for a selected one of NTT operations and inverse NTT operations.

12. A method comprising:
generating, by a random sample generator, a plurality of pseudorandom bitstreams;
multiplying, by a polynomial multiplier, a plurality of polynomial coefficients; and
powering off the polynomial multiplier and powering on the random sample generator to generate the plurality of pseudorandom bitstreams, and powering off the random sample generator and powering on the polynomial multiplier to multiple the plurality of polynomial coefficients.

13. The method of claim 12, comprising independently reading from and writing to a plurality of independently readable and writable memory units of a memory by random sample generator and the polynomial multiplier.

14. The method of claim 12, wherein the random sample generator and the polynomial multiplier execute a Cryptographic Suite for Algebraic Lattices (CRYSTALS) Kyber process for key encapsulation.

15. The method of claim 12, comprising generating the plurality of pseudorandom bitstreams using a Keccak mathematical function.

16. The method of claim 13, comprising:
reading seed data from the memory and executing a plurality of Keccak operations by a Keccak generator of the random sample generator to generate the plurality of pseudorandom bitstreams; and
generating the plurality of polynomial coefficients in parallel by a parser of the random sample generator from the plurality of pseudorandom bitstreams and writing the plurality of polynomial coefficients to the memory.

17. A system comprising:
a memory to store a key; and
key encapsulation mechanism circuitry to generate the key including:
random sample generator circuitry to generate a plurality of pseudorandom bitstreams;
polynomial multiplier circuitry to multiply a plurality of polynomial coefficients; and
a controller to power off the polynomial multiplier circuitry and power on the random sample generator circuitry to generate the plurality of pseudorandom bitstreams, and power off the random sample generator circuitry and power on the polynomial multiplier circuitry to multiple the plurality of polynomial coefficients.

18. The system of claim 17, wherein the key encapsulation mechanism circuitry comprise a memory including a plurality of independently readable and writable memory units, the random sample generator circuitry and the polynomial multiplier circuitry to independently read from and write to the plurality of independently readable and writable memory units.

19. The system of claim 17, wherein the random sample generator circuitry comprises:
Keccak generator circuitry to read seed data from the memory and execute a plurality of Keccak operations to generate the plurality of pseudorandom bitstreams; and
parser circuitry to generate the plurality of polynomial coefficients in parallel from the plurality of pseudorandom bitstreams and write the plurality of polynomial coefficients to the memory.

20. The system of claim 17, wherein the polynomial multiplier circuitry comprises:
a plurality of butterfly units to execute a selected one of number theoretic transform (NTT) operations and inverse NTT operations in parallel on the plurality of polynomial coefficients.
